(19) United States
(12) Patent Application Publication
(10) Pub. No.: US 2024/0303363 A1
(43) Pub. Date: Sep. 12, 2024

(54) TOPIC-BASED NATURAL LANGUAGE INTERACTION SEARCH

(71) Applicant: International Business Machine Corporation, Armonk, NY (US)

(72) Inventors: Jing Xing, Beijing (CN); Da Li LIU, Changping District (CN); Dong Yan Yang, Beijing (CN); Dan Li, Beijing (CN); Xi Bo Zhu, Beijing (CN); Ling Ling SH Hu, Shanghai (CN)

(21) Appl. No.: 18/119,069

(22) Filed: Mar. 8, 2023

(51) Int. Cl. G06F 21/62; G06F 21/60; G06F 40/40

(52) U.S. Cl. CPC G06F 21/6227; G06F 21/604; G06F 40/40; G06F 2221/2141

(57) ABSTRACT

A topic of a message in narrative text form is extracted from the message. The message and the topic are stored in a message repository. The message is produced from the message repository responsive to a search by an authorized user for messages relating to the topic.

### BACKGROUND

The present invention relates generally to a method, system, and computer program product for managing information from a natural language interaction. More particularly, the present invention relates to a method, system, and computer program product for topic-based natural language interaction search.

A natural language is a scripted (written) or a vocalized (spoken) language having a form that is employed by humans for primarily communicating with other humans or with systems having a natural language interface. Natural language processing (NLP) is a technique that facilitates exchange of information between humans and data processing systems. For example, one branch of NLP pertains to transforming human readable or human understandable content into machine usable data. For example, NLP engines are presently usable to accept input content such as a newspaper article or human speech, and produce structured data, such as an outline of the input content, most significant and least significant parts, a subject, a reference, dependencies within the content, and the like, from the given content. Another branch of NLP pertains to cognitive analytics, the process of analyzing available information or knowledge to create, infer, deduce, or derive new information.

Conversation-based collaboration tools are becoming common. A conversation-based collaboration tool is software that allows a member of a group of users to send messages to one or more members of the group, forming a natural language conversation or chat. Teams, especially when not all team members work in the same location, typically use a collaboration tool for rapid, informal, electronic interactions, much like those that could take place if the entire team worked in one room. Typically, the natural language conversation is conducted in text form. However, input to the conversation can also be converted from another modality, such as speech, into text for processing and transmission to other participants, then contributions to the conversation from other participants converted back into speech a human can hear.

A message is a unit of conversation. A message is a portion of narrative text, or another form of narrative communication converted into narrative text, communicated from a user to one or more users. A message need not conform to a grammar, but may also be any natural language word or phrase. A message can also include a collaborative action, such as sharing a file or a reference to a website. An interaction is a group of messages.

### SUMMARY

The illustrative embodiments provide a method, system, and computer program product. An embodiment includes a method that extracts, from a message in narrative text form using a natural language analysis, a topic of the message. An embodiment stores, in a message repository, the message and the topic. An embodiment produces, from the message repository responsive to a search by an authorized user for messages relating to the topic, the message.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for topic-based natural language interaction search in accordance with an illustrative embodiment;

FIG. 3 depicts an example of topic-based natural language interaction search in accordance with an illustrative embodiment;

FIG. 4 depicts a continued example of topic-based natural language interaction search in accordance with an illustrative embodiment;

FIG. 5 depicts a continued example of topic-based natural language interaction search in accordance with an illustrative embodiment;

FIG. 6 depicts a flowchart of an example process for topic-based natural language interaction search in accordance with an illustrative embodiment.

### DETAILED DESCRIPTION

The illustrative embodiments recognize that, while conversation-based collaboration tools provide an easy, natural way of communicating, the result is an undifferentiated flow of messages. An interaction, especially among more than two users, can include many threads, each proceeding on its own timeline and including numerous messages. When a user generates a new message in an interaction, it can be difficult to identify to which previous message (or action) is being addressed, or if the new message has no previous message (i.e., is the start of a new thread). Just as in face-to-face interactions, an interaction about one topic may segue into another topic, or the two topics may become intermingled, even if a tool provides different conversation channels for use in discussing different topics.

The illustrative embodiments recognize that this undifferentiated flow of messages is difficult to search effectively. Presently available conversation-based collaboration tools provide a keyword search capability, which returns messages, or message portions, in which a specified keyword or variant of a keyword is present. However, because participants may implicitly refer to subject matter discussed previously, without referencing a specific keyword, or refer to a subset of a topic without using the specific keyword that was queried, keyword searching is ineffective at locating all messages that are relevant to what a user is actually searching for. Other presently available conversation-based collaboration tools provide a search capability that requires a user to specify a topic as well as a search query.

The illustrative embodiments also recognize that, once found, relevant messages are difficult to share with others. Because messages are often related to other messages, sharing an individual message from a search result, without the context created by related messages, does not convey as much information as possible. In addition, some messages that a user might want to share are in private groups, and thus are unavailable for sharing to a non-member of a group even though the information itself is otherwise sharable.

Thus, the illustrative embodiments recognize that there is a need to improve search and sharing of messages exchanged within a conversation-based collaboration tool.

The illustrative embodiments recognize that the presently available tools or solutions do not address these needs or provide adequate solutions for these needs. The illustrative embodiments used to describe the invention generally address and solve the above-described problems and other problems related to topic-based natural language interaction search.

An embodiment can be implemented as a software application. The application implementing an embodiment can be configured as a modification of an existing conversation-based collaboration tool system, as a separate application that operates in conjunction with an existing conversation-based collaboration tool system, a standalone application, or some combination thereof.

Particularly, some illustrative embodiments provide a method that, using a natural language analysis, extracting a topic from a message in narrative text form, storing the message and the topic in a message repository, and producing, from the message repository responsive to a search by an authorized user for messages relating to the topic, the message.

An embodiment receives a message in narrative text form. An embodiment uses a natural language analysis to extract one or more topics of the message. One embodiment uses a presently available tokenizing technique to convert one or more words or other portions of the message to tokens, normalized portions of a message, then uses a presently available topic mapping technique to map tokens of the message to one or more topics. For example, a message including the word “lunch” and naming a restaurant might be classified into a “lunch restaurants” topic, or a “restaurants” topic with a “lunch” subtopic. Non-limiting examples of presently available topic mapping techniques include statistical analyses, sets of rules or heuristics, explicit and latent semantic analysis techniques, neural network-based techniques, and the like. Because messages in a conversation-based collaboration tool often relate to previous messages (e.g., a message asking about lunch might be followed by another message agreeing to lunch and suggesting a restaurant), another embodiment uses a presently available message relation technique to identify a previous message related to the received message and uses both messages to extract one or more topics of the received message. Other topic extraction techniques are presently available and contemplated within the scope of the illustrative embodiments.

An embodiment stores the message and its topic(s) in a message repository. Along with the message's topic, an embodiment stores additional metadata of the message, such as identifiers of the sender and recipients or group of recipients of the message, a timestamp of the message, and whether the message is public or nonpublic. An embodiment updates metadata of a stored message as necessary. For example, if a message's status is changed from nonpublic to public, or an embodiment determines an additional topic of a message from a later, related, message, the embodiment updates a stored message's metadata accordingly.

An embodiment receives a search query from a user. An embodiment treats the search query as a search for messages relating to a topic specified by the search query, and uses a presently available technique to search the message repository for messages responsive to the search. For example, if the search query specified “lunch restaurants”, an embodiment might search the message repository for messages previously tagged with the “lunch restaurants” topic, or a “restaurants” topic with a “lunch” subtopic, or a topic with a known relationship to “lunch” or “restaurant”. Any messages responsive to the search (i.e., matching the search query to within a threshold amount) are considered candidate messages.

An embodiment determines whether the user generating the search query is an authorized user of a candidate message. Authorized users of a message include a sender of the message, original recipients of a message (i.e., an named addressee or all members of a group in which the message was originally posted), other users who were previously given access to the message or a message of the same type or relating to the same topic as the message (e.g., a new member of a group assigned to Project A previously given access to all message relating to Project A). As well, all users of the interaction system are authorized users of a public message.

If the user is an authorized user of a candidate message, an embodiment presents the candidate message to the user as a result of the search query. One embodiment, as part of the presenting, invites (in a permission query) an authorized user to change the presented message's status—for example, to public if the message is not already public or to a non-public status if the message is public. Another embodiment, as part of the presenting, invites (in a permission query) an authorized user to change the presented message's status to authorize one or more specified other users, or a specified group of other users, to view a non-public message. One embodiment uses a set of rules associated with the message's topic to determine whether or not to invite the user to change the message's status. For example, one rule might specify that topics in a “leisure activities” category are allowed to be made public, while another rule might specify that topics in a list of company-confidential projects are not allowed to be made public. Another embodiment uses a presently available natural language processing technique to analyze the message and its topic(s) to determine whether or not to invite the user to change the message's status. For example, an embodiment might use a presently available natural language processing technique to analyze the message and its topic(s) to determine whether a message with two conflicting topics (e.g., lunch and Project A) can have a status change. Another embodiment uses a presently available machine learning technique to learn a particular user's invitation pattern or a rule for use in determine whether or not to invite the user to change the message's status. If an embodiment invites a user to change a status of a candidate message and the user does so, the embodiment updates the message's metadata accordingly, and stores the updated metadata in the message repository. One embodiment also stores a history of message status changes, along with the user who made a status change, in the message repository, for use in logging and machine learning implementations.

If a user generating a search query is not an authorized user of a candidate message, an embodiment does not present the candidate message to the user as a result of the search query. One embodiment indicates to the user that there is a responsive message the user is not authorized to view, while another embodiment does not so indicate. If there are additional candidate messages, an embodiment repeats the authorization determination and presentation for another candidate message.

The manner of topic-based natural language interaction search described herein is unavailable in the presently available methods in the technological field of endeavor pertaining to software-implemented conversation-based collaboration tools. A method of an embodiment described herein, when implemented to execute on a device or data processing system, comprises substantial advancement of the functionality of that device or data processing system in, using a natural language analysis, extracting a topic from a message in narrative text form, storing the message and the topic in a message repository, and producing, from the message repository responsive to a search by an authorized user for messages relating to the topic, the message.

The illustrative embodiments are described with respect to certain types of messages, topics, types of metadata, message statuses, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

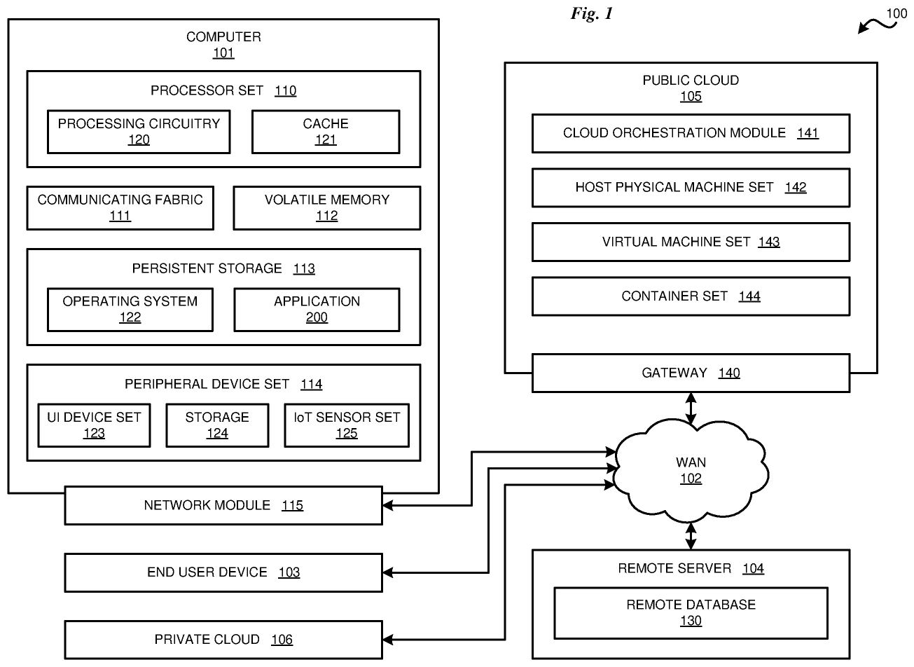

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description. FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements a topic-based natural language interaction search embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single- or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IoT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

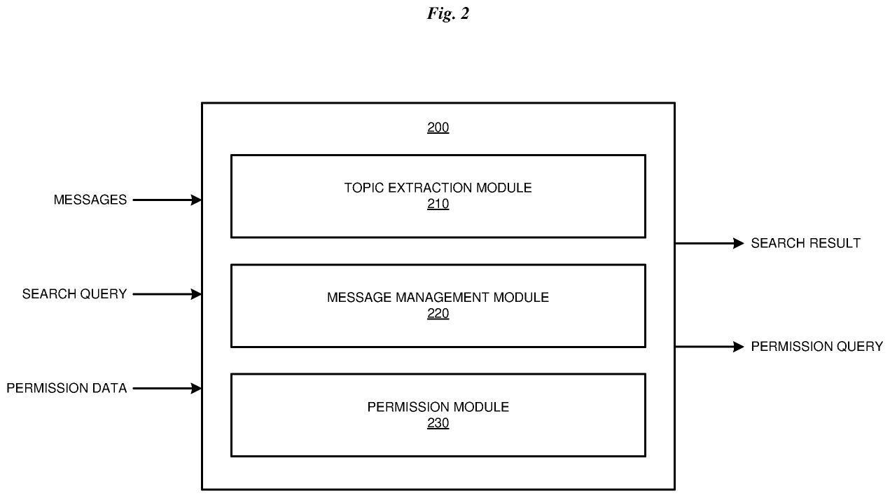

With reference to FIG. 2, this figure depicts a block diagram of an example configuration for topic-based natural language interaction search in accordance with an illustrative embodiment. Application 200 is the same as application 200 in FIG. 1.

Application 200 receives a message in narrative text form. Topic extraction module 210 uses a natural language analysis to extract one or more topics of the message. One implementation of module 210 uses a presently available tokenizing technique to convert one or more words or other portions of the message to tokens, normalized portions of a message, then uses a presently available topic mapping technique to map tokens of the message to one or more topics. For example, a message including the word “lunch” and naming a restaurant might be classified into a “lunch restaurants” topic, or a “restaurants” topic with a “lunch” subtopic. Non-limiting examples of presently available topic mapping techniques include statistical analyses, sets of rules or heuristics, explicit and latent semantic analysis techniques, neural network-based techniques, and the like. Because messages in a conversation-based collaboration tool often relate to previous messages (e.g., a message asking about lunch might be followed by another message agreeing to lunch and suggesting a restaurant), another implementation of module 210 uses a presently available message relation technique to identify a previous message related to the received message and uses both messages to extract one or more topics of the received message.

Message management module 220 stores the message and its topic(s) in a message repository. Along with the message's topic, module 220 stores additional metadata of the message, such as identifiers of the sender and recipients or group of recipients of the message, a timestamp of the message, and whether the message is public or nonpublic. Module 220 updates metadata of a stored message as necessary. For example, if a message's status is changed from nonpublic to public, or an embodiment determines an additional topic of a message from a later, related, message, module 220 updates a stored message's metadata accordingly.

Application 200 receives a search query from a user. Permission module 230 treats the search query as a search for messages relating to a topic specified by the search query, and uses a presently available technique to search the message repository for messages responsive to the search. For example, if the search query specified “lunch restaurants”, module 230 might search the message repository for messages previously tagged with the “lunch restaurants” topic, or a “restaurants” topic with a “lunch” subtopic, or a topic with a known relationship to “lunch” or “restaurant”. Any messages responsive to the search (i.e., matching the search query to within a threshold amount) are considered candidate messages.

Module 230 determines whether the user generating the search query is an authorized user of a candidate message. Authorized users of a message include a sender of the message, original recipients of a message (i.e., an named addressee or all members of a group in which the message was originally posted), other users who were previously given access to the message or a message of the same type or relating to the same topic as the message (e.g., a new member of a group assigned to Project A previously given access to all message relating to Project A). As well, all users of the interaction system are authorized users of a public message.

If the user is an authorized user of a candidate message, module 230 presents the candidate message to the user as a result of the search query. One implementation of module 230, as part of the presenting, invites (in a permission query) an authorized user to change the presented message's status—for example, to public if the message is not already public or to a non-public status if the message is public. Another implementation of module 230, as part of the presenting, invites (in a permission query) an authorized user to change the presented message's status to authorize one or more specified other users, or a specified group of other users, to view a non-public message. One implementation of module 230 uses a set of rules associated with the message's topic to determine whether or not to invite the user to change the message's status. For example, one rule might specify that topics in a “leisure activities” category are allowed to be made public, while another rule might specify that topics in a list of company-confidential projects are not allowed to be made public. Another implementation of module 230 uses a presently available natural language processing technique to analyze the message and its topic(s) to determine whether or not to invite the user to change the message's status. For example, the implementation might use a presently available natural language processing technique to analyze the message and its topic(s) to determine whether a message with two conflicting topics (e.g., lunch and Project A) can have a status change. Another implementation of module 230 uses a presently available machine learning technique to learn a particular user's invitation pattern or a rule for use in determine whether or not to invite the user to change the message's status. If module 230 invites a user to change a status of a candidate message and the user does so, module 220 updates the message's metadata accordingly, and stores the updated metadata in the message repository. One implementation of modules 220 and 230 also stores a history of message status changes, along with the user who made a status change, in the message repository, for use in logging and machine learning implementations.

If a user generating a search query is not an authorized user of a candidate message, module 230 does not present the candidate message to the user as a result of the search query. One implementation of module 230 indicates to the user that there is a responsive message the user is not authorized to view, while another implementation of module 230 does not so indicate. If there are additional candidate messages, module 230 repeats the authorization determination and presentation for another candidate message.

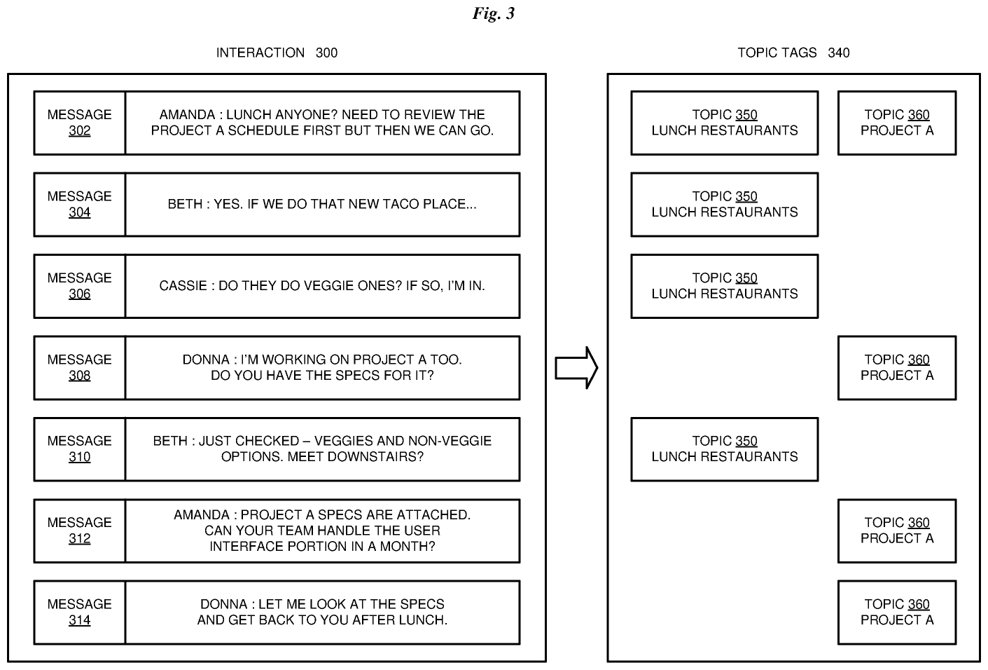

With reference to FIG. 3, this figure depicts an example of topic-based natural language interaction search in accordance with an illustrative embodiment. The example can be executed using application 200 in FIG. 2.

Interaction 300 includes messages 302, 304, 306, 308, 310, 312, and 314. Some of the messages discuss lunch and a particular taco restaurant, while other messages discuss Project A and message 302 discusses both. Thus, topic extraction module 210 tags messages 302, 304, 306, 308, 310, 312, and 314 with topic tags 350, 360, or both. Topic tags 350 and 360 are two topic tags in topic tags 340, which can include additional topic tags relating to additional messages.

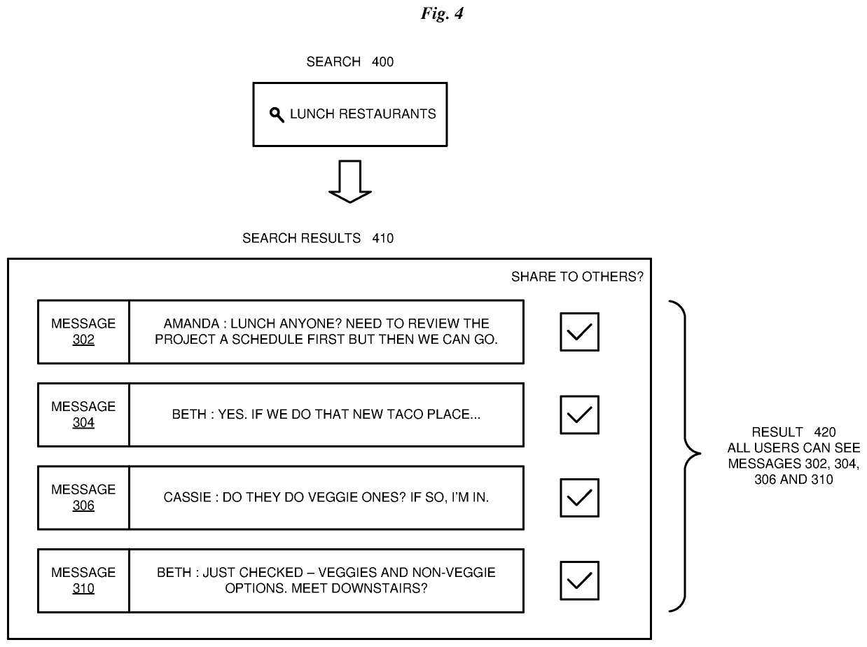

With reference to FIG. 4, this figure depicts a continued example of topic-based natural language interaction search in accordance with an illustrative embodiment. Messages 302, 304, 306, and 310 are the same as messages 302, 304, 306, and 310 in FIG. 3.

As depicted, search 400, for lunch restaurants, has produced search results 410, including messages 302, 304, 306, and 310. Because the user generating search 400 is in the same chat group as messages 302, 304, 306, and 310 were posted in, the user is an authorized user and has been presented with search results 410. The user has also been invited to make search results 410 public, and has done so, generating result 420—all users can now see messages 302, 304, 306, and 310 as search results.

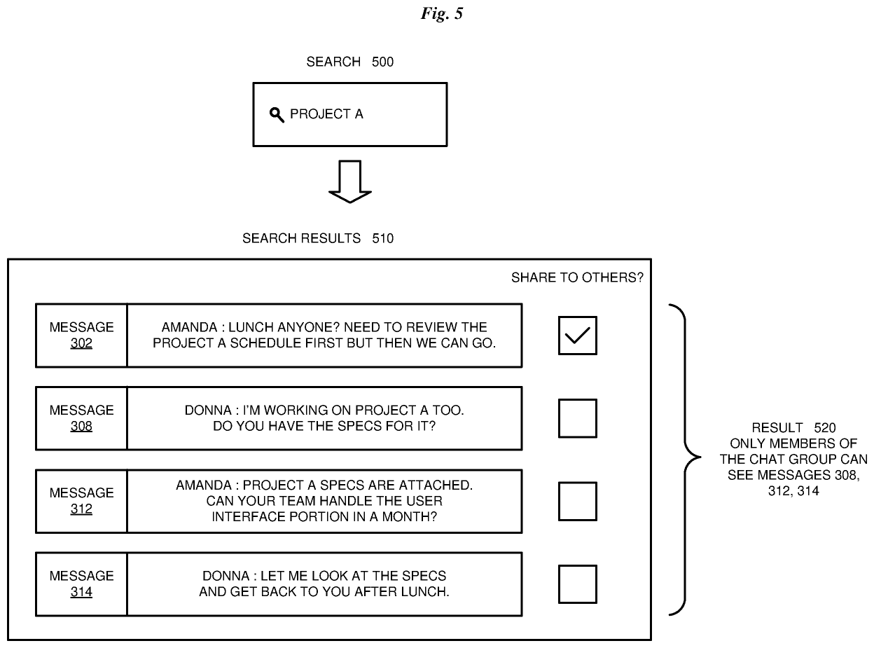

With reference to FIG. 5, this figure depicts a continued example of topic-based natural language interaction search in accordance with an illustrative embodiment. Messages 302, 308, 312, and 314 are the same as messages 302, 308, 312, and 314 in FIG. 3.

As depicted, search 500, for lunch restaurants, has produced search results 510, including messages 302, 308, 312, and 314. Because the user generating search 500 is in the same chat group as messages 302, 308, 312, and 314 were posted in, the user is an authorized user and has been presented with search results 510. The user has also been invited to make search results 510 public. However, the user has made only message 302 public, generating result 520—all users can now see message 302, while only members of the chat group can see messages 308, 312, and 314 as search results.

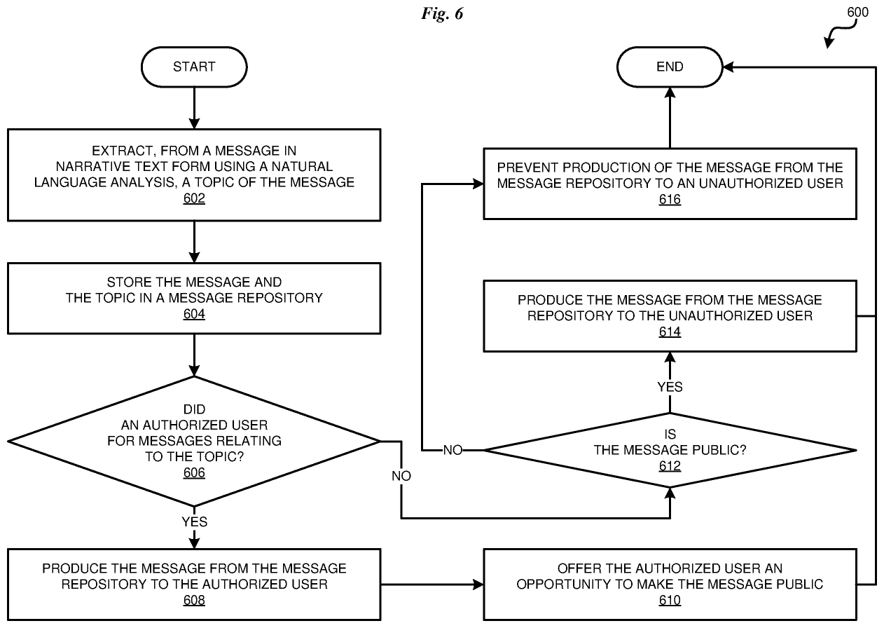

With reference to FIG. 6, this figure depicts a flowchart of an example process for topic-based natural language interaction search in accordance with an illustrative embodiment. Process 600 can be implemented in application 200 in FIG. 2.

In block 602, the application extracts, from a message in narrative text form using a natural language analysis, a topic of the message. In block 604, the application stores the message and the topic in a message repository. In block 606, the application determines whether an authorized user searched for messages relating to the topic. If yes, (“YES” path of block 606), in block 608 the application produces the message from the message repository to the authorized user, and in block 610 the application offers the authorized user an opportunity to make the message public. Otherwise (“NO” path of block 608), in block 612 the application determines whether the message is public. If yes, (“YES” path of block 612), in block 614 the application produces the message from the message repository to the unauthorized user. Otherwise (“NO” path of block 612), in block 616 the application prevents production of the message from the message repository to an unauthorized user. After blocks 610, 614, and 616, the application ends.

Thus, a computer implemented method, system or apparatus, and computer program product are provided in the illustrative embodiments for topic-based natural language interaction search and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

What is claimed is:

1. A computer-implemented method comprising:
extracting, from a message in narrative text form using a natural language analysis, a topic of the message;
storing, in a message repository, the message and the topic; and
producing, from the message repository responsive to a search by an authorized user for messages relating to the topic, the message.

2. The computer-implemented method of claim 1, further comprising:
preventing production, from the message repository responsive to a search by an unauthorized user for messages relating to the topic, the message.

3. The computer-implemented method of claim 1, further comprising:
inviting, as part of the producing, an authorized user to alter a status of the message.

4. The computer-implemented method of claim 3, wherein the inviting is performed responsive to a determination, using the topic, that altering the status of the message is allowed.

5. The computer-implemented method of claim 1, further comprising:
extracting, from a second message in narrative text form using a natural language analysis, a second topic of the second message;
storing, in the message repository, the second message and the second topic; and
producing, from the message repository responsive to a search by an unauthorized user for messages relating to the second topic and responsive to a determination, by an authorized user, that the second message is public, the second message.

6. The computer-implemented method of claim 1, wherein an authorization status of the message is stored in the message repository.

7. A computer program product comprising one or more computer readable storage medium, and program instructions collectively stored on the one or more computer readable storage medium, the program instructions executable by a processor to cause the processor to perform operations comprising:
extracting, from a message in narrative text form using a natural language analysis, a topic of the message;
storing, in a message repository, the message and the topic; and
producing, from the message repository responsive to a search by an authorized user for messages relating to the topic, the message.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, further comprising:
preventing production, from the message repository responsive to a search by an unauthorized user for messages relating to the topic, the message.

11. The computer program product of claim 7, further comprising:
inviting, as part of the producing, an authorized user to alter a status of the message.

12. The computer program product of claim 11, wherein the inviting is performed responsive to a determination, using the topic, that altering the status of the message is allowed.

13. The computer program product of claim 7, further comprising:
extracting, from a second message in narrative text form using a natural language analysis, a second topic of the second message;
storing, in the message repository, the second message and the second topic; and
producing, from the message repository responsive to a search by an unauthorized user for messages relating to the second topic and responsive to a determination, by an authorized user, that the second message is public, the second message.

14. The computer program product of claim 7, wherein an authorization status of the message is stored in the message repository.

15. A computer system comprising a processor and one or more computer readable storage media, and program instructions collectively stored on the one or more computer readable storage media, the program instructions executable by the processor to cause the processor to perform operations comprising:
extracting, from a message in narrative text form using a natural language analysis, a topic of the message;
storing, in a message repository, the message and the topic; and
producing, from the message repository responsive to a search by an authorized user for messages relating to the topic, the message.

16. The computer system of claim 15, further comprising:
preventing production, from the message repository responsive to a search by an unauthorized user for messages relating to the topic, the message.

17. The computer system of claim 15, further comprising:
inviting, as part of the producing, an authorized user to alter a status of the message.

18. The computer system of claim 17, wherein the inviting is performed responsive to a determination, using the topic, that altering the status of the message is allowed.

19. The computer system of claim 15, further comprising:
extracting, from a second message in narrative text form using a natural language analysis, a second topic of the second message;
storing, in the message repository, the second message and the second topic; and
producing, from the message repository responsive to a search by an unauthorized user for messages relating to the second topic and responsive to a determination, by an authorized user, that the second message is public, the second message.

20. The computer system of claim 15, wherein an authorization status of the message is stored in the message repository.
